(19) United States
(12) Patent Application Publication
(10) Pub. No.: US 2011/0054058 A1
(43) Pub. Date: Mar. 3, 2011

(54) Emulsified polyol and resultant foam therefrom

(76) Inventors: William Crooker, Maple Grove, MN (US); Bryan Clem, Mound, MN (US)

(21) Appl. No.: 12/584,093

(22) Filed: Aug. 31, 2009

(51) Int. Cl. C08J 9/00

(52) U.S. Cl. 521/170

(57) ABSTRACT

An improved polyol, having a first component combined with a second component, one of the first and second components being hydrophobic and one of the first and second components being hydrophillic, at least one of the components being in a stable encapsulation or being in a stable emulsion, desirably formed of calcium carbonate and silicon dioxide.

### FIELD OF THE INVENTION

The present invention relates to polyols and more particularly polyols in a stable emulsion.

### BACKGROUND OF THE INVENTION

Foams are used in many different areas of modern culture, including drinking cups, boats, floatation devices, insulation, structural components, fillers and in many other ways. Foams can be made mechanically or chemically. Chemical foams are constructed through mixing compound A (also known as isocyanate) and compound B (also known as polyol). Reacting compounds A and B result in foam. A number of problems arise in the chemical foam area.

Water found in the polyol, ideally forms a small bead, surrounded by the oil, also found in the polyol. The exothermic reaction involves isocyanate (part A) and polyol (part B) reacting to form urethane linkages urea and carbon dioxide. However, safety and environmental concerns have made isocyanate and polyol increasingly more difficult to effectively combine.

Compound A (isocyanate) was traditionally made of toluene diisocyanate, (herein TDI). TDI is a compound with three reactive cites. On occasion only one or two cites would react in making the foam. The unreacted cites can react with the human body, ultimately resulting in cancer. Methylene diphenyl diisocyanate, hereinafter MDI, has only one reaction cite and was developed specifically to avert the carcinogenic character of TDI. MDI, however, is difficult to use in the production of green, rigid foams, especially those with high whiteness.

As one might surmise, the water in the polyol resists remaining in small beads within a bath of oil, which largely makes up the balance of the polyol. The oil, less dense and hydrophobic separates and forms a layer suspended above a layer of water.

Foam producers compensate by vigorously and constantly mixing the polyol. Still, the water is not easily managed and will collect in pools within the emerging polyol. Also the combination of an amine catalyst with water used to provide a closed cell foam create a stability issue (shrinkage and collapse) in the production of the foam. Occasionally, shrinkage of the foam may occur, providing a distorted and unusable foam. “ . . . [A] solution to the shrinkage problem would be highly desirable in the polyurethanes manufacturing community.” Szycher's Handbook of Polyurethanes, P 10-16, copyright 1999. In other situations, the bottom of the foam blank is trimmed off to remove the oversized and irregular shaped cells.

The polyol historically was made of petroleum. Environmental concerns have driven the market toward polyols based upon renewable resources. Renewable resources is defined in ASTM D6866. These polyols based upon renewable resources are more difficult to react into commercially acceptable foams. According to Plastics Technology feature article “Polyurethane Bio-Based Materials Capture Attention”, written by Lilli Manolis Sherman, “To date NOPs [natural oil polyol] typically have had low hydroxyl functionalities and relatively high equivalent weight, which make them more suitable for use in solid urethanes and flexible foams, not rigid insulating foams. In addition, they lack solubility for blowing agents such as hydrocarbons or conventional polyols.”

The polyol may be described as 96% renewable, meaning that the renewable content in the polyol constitutes 96% of the whole. The percent renewability is roughly cut in half when mixed with isocyanate, since the isocyanate is not itself renewable. Thus, a polyol that is 10% renewable yields a foam that is roughly 5% renewable. The United States Department of Agriculture's proposed guideline defining a “green foam” as a foam that has at least 8% renewable content.

As the percent renewability rises, the polyol becomes more and more difficult to properly react with the isocyanate. Some polyols purported have 96% renewable content. However, forming a stable green closed cell rigid foam has thus far been elusive. The foam suffers from shrinkage and collapse, being unusable and unsaleable.

Whiteness, as to foams, is much more than a color. White is an indicator of quality and age. Lower quality foams and old foams are yellow. Increasing the difficulty of making the foam, e.g., using MDI and a polyol with high renewable content yields yellow foams, illustrative of the poor quality.

What is needed is a polyol wherein the water remains in an emulsion. Desirably, the polyol has a high renewable content and reacts well with MDI forming a stable, green foam with high whiteness that is rigid and closed cell. Ideally, the interstitial space between the cells contain a rigid matrix, adding support and structure to the cell walls of the finished foam.

### SUMMARY OF THE INVENTION

The present invention is a polyol wherein the water remains in an emulsion. The polyol may have a high renewable content and reacts well with MDI forming a stable, green foam with high whiteness that is rigid and closed cell. The interstitial space between the cells, resulting from the polyol, contains a rigid matrix, adding support and structure to the cell walls in the finished foam.

This improved polyol, includes a first component combined with a second component. The first or second component is hydrophobic while the other is hydrophillic. At least one of the components is in a stable encapsulation or in a stable emulsion.

Advantageously, the present polyol may have a high renewable content.

As a further advantage, the present polyol is suitable for forming green rigid foam.

As another advantage, the present polyol is usable with MDI.

A further advantage is that the present polyol provide interstitial structure, augmenting the strength of the rigid foam.

The present polyol for a rigid foam with a high whiteness, indicating quality and age of the foam.

These and other advantages will be made clear upon reading the below description with reference to the appended figures.

### DESCRIPTION OF THE FIGURES

FIG. 1 shows a side view of a beaker containing stabilized prior art polyol;

FIG. 2 shows a side view of a beaker containing stabilized polyol of the present invention;

FIG. 3 is a schematic drawing of the mixing machine;

FIG. 4 is a front end view of the gun of the mixing machine;

FIG. 5 is a side view of the static mixer, showing the position of the screen;

FIG. 6 is a top or bottom view of the screen;

FIG. 7 is a perspective view of a mold;

FIG. 8 is a perspective view of a blank in the design of a surf board blank;

FIG. 9 is a side view of an insert for a surf board blank; and

FIG. 10 is a blow-up of a portion of foam showing the cells, interstitial space and crystalline matrix

These figures show the preferred embodiment of the present invention and are not to be considered limiting of the invention.

### DETAILED DESCRIPTION

The present system may form closed cell foam 114 from petroleum and non-petroleum based polyols in the mode and manner described herebelow from a variety of aspects. The method of preparing and composition of compound B, apparatus for mixing and molding compounds A and B, method of mixing compounds A and B and resultant foam 114 are set forth in detail below. The best mode of each are described in sufficient detail to allow one skilled in the art to make and use the various inventions described herein.

The improved polyol, may include a first component combined with a second component. Either the first or second components preferably are hydrophobic and the other is hydrophillic. At least one of the components may be in a stable encapsulation or emulsion. For instance, the hydrophobic component may be oil 12 or more preferably renewable oil 12. The hydrophilic compound may be water 14. One of the components may be encapsulated or in an emulsion.

The improved polyol may include calcium carbonate and silicon dioxide. As such, the calcium carbonate and silicon dioxide encapsulate or emulsify one of the first and second components. Desirably, the calcium carbonate constitutes between 2% and 30% by weight of the combined weight of the first and second components and the silicon dioxide constitutes between 0.6% and 30% by weight of the combined weight of the first and second components.

In one embodiment, the improved polyol, may include water 14, oil 12, CaCO₃; and SiO₂, wherein the water 14, CaCO₃ and SiO₂ form an emulsion. Alternatively, the improved polyol, may include water 14, oil 12, CaCO₃; and SiO₂, wherein the CaCO₃ and SiO₂ encapsulate the water 14. From a different perspective, the improved polyol may include water 14, oil 12; the weight of the water 14 and weight of the oil 12 forming a total water-oil weight; CaCO₃, wherein a weight of the CaCO₃ is between 2% and 30% of the water-oil weight; and SiO₂, wherein a weight of the SiO₂ is between 0.6% and 30% of the water-oil weight.

This improved polyol, compounds B may be joined with an isocyanate, preferably MDI, in manners known in the trade or in the manner described below. The resultant foam 114 may be rigid, green, with high whiteness, closed cell foam 114.

### Methodology of Preparing and Composition of Compound B

The present inventive methodology includes providing compounds for mixing Compounds B, which preferably includes a current commercial polyol, calcium carbonate (CaCO₃), and silicon dioxide (SiO₂), which may be in the form of diatomaceous earth (DE). Commercial polyols are primarily oil 12 and water 14. Some polyols don't contain a significant amount of water so the water concentration is controlled by the foam manufacturer to regular the foam density outcome. Although other additives may be found in commercial polyols, none are known to have an effect on the system disclosed herein.

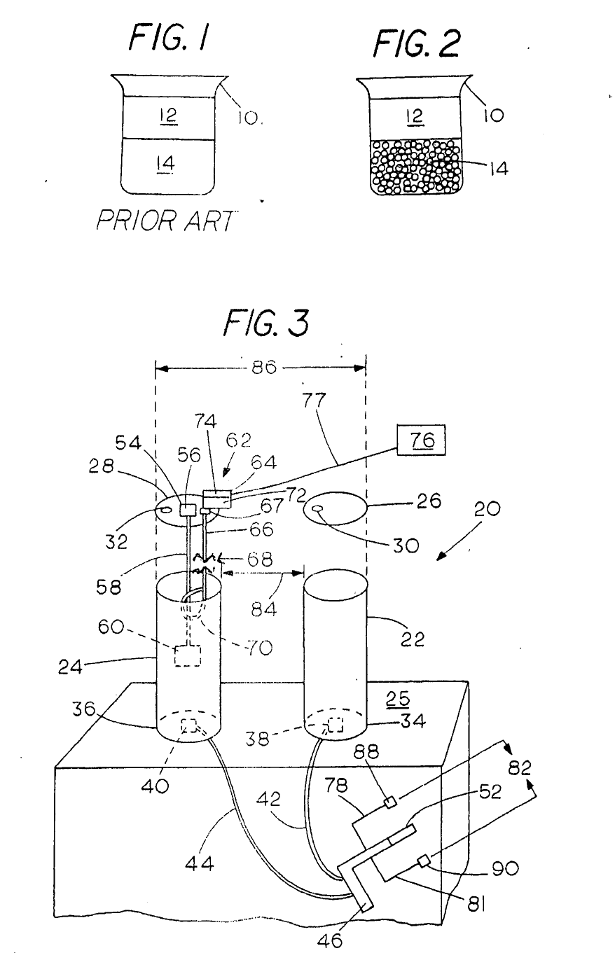

Polyol, as shown in FIG. 1, is typically presented in a container 10. A layer of primarily oil 12 is found positioned above a layer of primarily water 14. Heretofore, vigorous mixing was employed prior to making a foam 114 with marginal success, since the separation of oil 12 and water 14 occurs as the polyol is being mixed. As shown in FIG. 2, present improved polyol, the layer of oil 12 is positioned atop encapsulated or emulsified water 14. The droplets of water 14 remain small and are stable. The emulsified or encapsulated water 14 readily mixes with the oil 12 and remains mixed through the forming of foam 114. That is, the oil 12 and water 14 in the present improved polyol is substantially more stable emulsion than the present available polyols.

The amounts to be provided are as percentage of the total weight of the polyol.

TABLE 1

| | Desired | Preferred | Most |
|---|---|---|---|
| Additive | Range | Range | Desired |
| Calcium Carbonate | 2%-30% | 4%-16% | 4% |
| (CaCO₃) | | | |
| Silicon dioxide (SiO₂) | 2%-30% | 4%-20% | 8% |

These additives provide for a stable Compound B that will remain on a shelf for year without the pooling of water 14 found with what has heretofore been known in the commercially available polyols. Instead, the water 14 remains encapsulated or in an emulsion with no visual sign of pooling. The oil 12 tends to layer above the aqueous emulsion, but readily mixes with the aqueous emulsion. Once mixed the improved polyol remains in a stable mix sufficiently long to form foam 114.

The foam tends to have scorching, large cell size, more yellow, softer, less aragonite and faster reaction rate as the calcium carbonate is reduced. The foam tends to be more dense, harder, whiter, finer cell size, low to no scorching as the calcium carbonate is increased. At a certain point, the addition of more calcium carbonate has no additional utility.

The foam, as the silicon dioxide is decreased, tends to be less consistent in cell size and integrity. The foam, as the silicon dioxide is increased, tends also lose consistency in cell size and cell integrity. Optimal levels are set forth above in table 1.

Beneficially, CaCO₃ keeps the heat of the reactions in co-mingled compound A and compound B lower. The SiO₂ may be provided in the form of diatomaceous earth (DE), which is generally 83.7% SiO₂ with the balance being other naturally occurring oxides. In combination, the CACo₃ and SiO₂ encapsulate the water 14 in small beads, forming a stable emulsion.

The improved polyol may optionally include one or more additional additives including, but not limited to the following: Titanium Oxide (TiO₂), INT-420/2C, herein after “INT 420”, Dapco 5357 (a surfactant), Dapco T12 (a catalyst), and glycerin. INT 420 is a proprietary mixture available through Axel Plastics Research Laboratories, Inc, having an address of P.O. Box 855, 58-20 Broadway, Woodside, N.Y. 11377-0855. Dapco 5357 and Dapco T12 are a proprietary mixtures available through Air Products and Chemicals, Inc., having an address of 7201 Hamilton Boulevard., Allentown, Pa. 18195-1501. A suitable glycerin, more particularly vegetable glycerin, is available from Frontier Corp. Box 299, Norway, Iowa 52318.

TiO₂, a catalyst, is not believed to encapsulate or stabilize the water 14. INT 420, a blowing agent, has generally been found to be unnecessary. Dapco 5357 is a surfactant. Dapco T12 is believed to change the surface tensions and increases the probability of the polyol-isocyanate reaction to proceed at a predictable rate. These may be added in the ratios:

TABLE 2

| | Desired | Preferred | Most |
|---|---|---|---|
| Additive | Range | Range | Desired |
| Titanium Oxide | 0.2%-1% | 0.4%-0.8% | 0.6% |
| (TiO₂) | | | |
| INT 420 | 0.0%-10% | 1%-6% | 2.6% |
| Dapco 5357 | 1%-6% | 1%-3% | 3% |
| Dapco T12 | 0.1%-1.5% | 0.3-0.9% | 0.3% |
| Glycerin | 1%-30% | 1%-1.6% | 1.2% |

Compound B is desirably prepared by mixing each additive one at a time and thoroughly mixing between each additive. The desired mixing order is in the order listed in tables 1 and 2 and such order yields improved results. Thoroughly mixing is defined as mixing until a visible homogenous mix is obtained.

Various Compound B mixtures have been prepared with a variety of polyols available from a variety of sources. The following examples illustrate the breadth of the ranges.

### Example 1

Polyol sold under the tradename BiOH, was obtained through Cargil, Inc., having a business address of 15407 McGinty, Road West, Wayzata, Minn. 55391 was mixed according to the above stated mixing order with the below stated additives according to the following percentages:

| Additive | Percentage Weight |
|---|---|
| Calcium Carbonate (CaCO₃) | 4% |
| Silicon dioxide (SiO₂) | 8% |
| Titanium Oxide (TiO₂) | 0.6% |
| INT 420 | 2.6% |

A stable and suitable compound B was obtained.

Both BiOH and the improved polyol described in this example 1 were tested according to SF200 test method (“Accelerated aging”). Pooling of water was noted in at 686 hours (29 days) in the BiOH sample. Water droplet size in the improved polyol remained less than 0.020 inches in diameter at 1,736 hours (72 days) and approximately 30 droplets per 0.25 inches squared at 9,170 hours.

### Example 2

Polyol sold under the tradename Agrol was obtained from Biobased Technologies, Inc., having a business address of 1475 W. Cato Springs Road, Fayetteville, Ark. 72701, was mixed according to the above stated mixing order with the below stated additives according to the following percentages:

| Additive | Percentage Weight |
|---|---|
| Calcium Carbonate (CaCO₃) | 4% |
| Silicon dioxide (SiO₂) | 8% |
| Titanium Oxide (TiO₂) | 0% |
| INT 420 | 2.6% |
| Dapco 5357 | 4.0% |
| Dapco T12 | 0.15% |

A stable and suitable compound B, polyol, was obtained.

Both Agrol and the improved polyol described in this example 2 were tested according to SF200 test method (“Accelerated aging”). No visible water was noted after 9,170 hours in the Agrol sample. Water droplet size in the improved polyol remained less than 0.020 inches in diameter at 1,736 hours (72 days) and approximately 6 droplets per 0.25 inches squared at 9,170 hours.

### Example 3

Polyol sold under the tradename Soyol was obtained from Urethane Soy Systems, Inc., having a business address of 100 Caspian Avenue, P.O. Box 590, Volga, S. Dak. 57071-590 was mixed according to the above stated mixing order with the below stated additives according to the following percentages:

| Additive | Percentage Weight |
|---|---|
| Calcium Carbonate (CaCO₃) | 16% |
| Silicon dioxide (SiO₂) | 16% |
| Titanium Oxide (TiO₂) | .6% |
| INT 420 | 2.6% |
| Dapco 5357 | 0% |
| Dapco T12 | 0% |
| Glycerin | 30% |

A stable and suitable compound B, polyol, was obtained. Both Soyol and the improved polyol described in this example 3 were tested according to SF200 test method (“Accelerated aging”). Water globules were noted at 2,394 hours. Water droplet size in the improved polyol remained less than 0.020 inches in diameter at 1,736 hours (72 days) and approximately 15 droplets per 0.25 inches squared at 9,170 hours.

### Example 4

Polyol sold under the tradename TC-300 Part B was obtained from BJB Enterprises, Inc., having a business address of 14791 Franklin Avenue, Tustin, Calif. 92780 was mixed according to the above stated mixing order with the below stated additives according to the following percentages:

| Additive | Percentage Weight |
|---|---|
| Calcium Carbonate (CaCO₃) | 12% |
| Silicon dioxide (SiO₂) | 0.68% |
| Titanium Oxide (TiO₂) | 0.6% |
| INT 420 | 0% |

A stable and suitable compound B, polyol, was obtained. Both TC-300 and the improved polyol described in this example 4 were tested according to SF200 test method (“Accelerated aging”). No visible water was noted to the naked eye at 9,170 hours.

### Example 5

Polyol sold under the tradename TC-300 Part B was obtained from BJB Enterprises, Inc., was mixed according to the above stated mixing order with the below stated additives according to the following percentages:

| Additive | Percentage Weight |
|---|---|
| Calcium Carbonate (CaCO₃) | 0% |
| Silicon dioxide (SiO₂) | 0% |
| Titanium Oxide (TiO₂) | 0% |
| INT 420 | 0% |

A stable, but not suitable compound B, polyol, was obtained. The polyol TC-300 was tested according to SF200 test method (“Accelerated aging”). No visible water was noted to the naked eye at 9,170 hours. A fuzzy precipitate was noted on the bottom of the container.

### Example 6

Polyol sold under the tradename Soyol was obtained from Urethane Soy Systems, Inc., having a business address of 100 Caspian Avenue, P.O. Box 590, Volga, S. Dak. 57071-590 was mixed according to the above stated mixing order with the below stated additives according to the following percentages:

| Additive | Percentage Weight |
|---|---|
| Calcium Carbonate (CaCO₃) | 30% |
| Silicon dioxide (SiO₂) | 4% |
| Titanium Oxide (TiO₂) | .1% |
| INT 420 | 0% |
| Dapco 5357 | 0% |
| Dapco T12 | .6% |
| Glycerin | 30% |

A stable and suitable compound B, polyol, was obtained. When reacted resultant foam exhibited large cell size and off white color.

### Example 7

Polyol sold under the tradename TC-300 Part B was obtained from BJB Enterprises, Inc., having a business address of 14791 Franklin Avenue, Tustin, Calif. 92780 was mixed according to the above stated mixing order with the below stated additives according to the following percentages:

| Additive | Percentage Weight |
|---|---|
| Calcium Carbonate (CaCO₃) | 2% |
| Silicon dioxide (SiO₂) | 1% |
| Titanium Oxide (TiO₂) | 0.8% |
| INT 420 | 0% |

A stable and suitable compound B, polyol, was obtained. When reacted, foam exhibited large cell size and high whiteness.

### Example 8

Polyol sold under the tradename TC-300 Part B was obtained from BJB Enterprises, Inc., was mixed according to the above stated mixing order with the below stated additives according to the following percentages:

| Additive | Percentage Weight |
|---|---|
| Calcium Carbonate (CaCO₃) | 20% |
| Silicon dioxide (SiO₂) | 30% |
| Titanium Oxide (TiO₂) | 0% |
| INT 420 | 0% |

A stable and suitable compound B, polyol, was obtained. When reacted, foam exhibited large cell size and high density.

### Example 9

Polyol sold under the tradename BiOH, was obtained through Cargil, Inc., having a business address of 15407 McGinty, Road West, Wayzata, Minn. 55391 was mixed according to the above stated mixing order with the below stated additives according to the following percentages:

| Additive | Percentage Weight |
|---|---|
| Calcium Carbonate (CaCO₃) | 20% |
| Silicon dioxide (SiO₂) | 2% |
| Titanium Oxide (TiO₂) | .08% |
| INT 420 | 0% |

A stable and suitable compound B was obtained. When reacted, foam exhibited fine cell size and high density.

### Example 10

Polyol sold under the tradename TC-300 Part B was obtained from BJB Enterprises, Inc., having a business address of 14791 Franklin Avenue, Tustin, Calif. 92780 was mixed according to the above stated mixing order with the below stated additives according to the following percentages:

| Additive | Percentage Weight |
|---|---|
| Calcium Carbonate (CaCO₃) | 4% |
| Silicon dioxide (SiO₂) | 8% |
| Titanium Oxide (TiO₂) | 0.6% |
| INT 420 | 0% |

A stable and suitable compound B, polyol, was obtained. When reacted, foam exhibited fine cell size, high density and high whiteness.

### Example 11

Polyol sold under the tradename TC-300 Part B was obtained from BJB Enterprises, Inc., having a business address of 14791 Franklin Avenue, Tustin, Calif. 92780 was mixed according to the above stated mixing order with the below stated additives according to the following percentages:

| Additive | Percentage Weight |
|---|---|
| Calcium Carbonate (CaCO₃) | 16% |
| Silicon dioxide (SiO₂) | 8% |
| Titanium Oxide (TiO₂) | 0.6% |
| INT 420 | 0% |

A stable and suitable compound B, polyol, was obtained. When reacted, foam exhibited fine cell size, high density and high whiteness.

### Example 12

Polyol sold under the tradename Agrol was obtained from Biobased Technologies, Inc., having a business address of 1475 W. Cato Springs Road, Fayetteville, Ark. 72701, was mixed according to the above stated mixing order with the below stated additives according to the following percentages:

| Additive | Percentage Weight |
|---|---|
| Calcium Carbonate (CaCO₃) | 4% |
| Silicon dioxide (SiO₂) | 8% |
| Titanium Oxide (TiO₂) | 0% |
| INT 420 | 2.6% |
| Dapco 5357 | 4.0% |
| Dapco T12 | 0.15% |

A stable and suitable compound B, polyol, was obtained. When reacted, foam exhibited fine cell size, high density and high whiteness.

### Example 13

Polyol sold under the tradename Soyol was obtained from Urethane Soy Systems, Inc., having a business address of 100 Caspian Avenue, P.O. Box 590, Volga, S. Dak. 57071-590 was mixed according to the above stated mixing order with the below stated additives according to the following percentages:

| Additive | Percentage Weight |
|---|---|
| Calcium Carbonate (CaCO₃) | 20% |
| Silicon dioxide (SiO₂) | 16% |
| Titanium Oxide (TiO₂) | 0% |
| INT 420 | 4% |
| Dapco 5357 | 3% |
| Dapco T12 | .3% |
| Glycerin | 30% |

A stable and suitable compound B, polyol, was obtained. When reacted, foam exhibited fine cell size, high density and high whiteness.

### Example 14

Polyol sold under the tradename BiOH, was obtained through Cargil, Inc., having a business address of 15407 McGinty, Road West, Wayzata, Minn. 55391 was mixed according to the above stated mixing order with the below stated additives according to the following percentages:

| Additive | Percentage Weight |
|---|---|
| Calcium Carbonate (CaCO₃) | 4% |
| Silicon dioxide (SiO₂) | 8% |
| Titanium Oxide (TiO₂) | 0.6% |
| INT 420 | 2.6% |

A stable and suitable compound B was obtained. When reacted, foam exhibited fine cell size, high density and high whiteness. Reacted material exhibited no shrinkage or collapse.

### Example 15

Polyol sold under the tradename Agrol was obtained from Biobased Technologies, Inc., having a business address of 1475 W. Cato Springs Road, Fayetteville, Ark. 72701, was mixed according to the above stated mixing order with the below stated additives according to the following percentages:

| Additive | Percentage Weight |
|---|---|
| Calcium Carbonate (CaCO₃) | 4% |
| Silicon dioxide (SiO₂) | 8% |
| Titanium Oxide (TiO₂) | 0% |
| INT 420 | 2.6% |
| Dapco 5357 | 4.0% |
| Dapco T12 | 0.15% |

A stable and suitable compound B, polyol, was obtained. When reacted, foam exhibited fine cell size, high density and high whiteness. Reacted material exhibited no shrinkage or collapse.

### Example 16

Polyol sold under the tradename TC-300 Part B was obtained from BJB Enterprises, Inc., having a business address of 14791 Franklin Avenue, Tustin, Calif. 92780 was mixed according to the above stated mixing order with the below stated additives according to the following percentages:

| Additive | Percentage Weight |
|---|---|
| Calcium Carbonate (CaCO₃) | 4% |
| Silicon dioxide (SiO₂) | 8% |
| Titanium Oxide (TiO₂) | 0.6% |
| INT 420 | 0% |

A stable and suitable compound B, polyol, was obtained. When reacted, foam exhibited fine cell size, high density and high whiteness. Reacted material exhibited no shrinkage or collapse.

### Apparatus for mixing compounds A and B

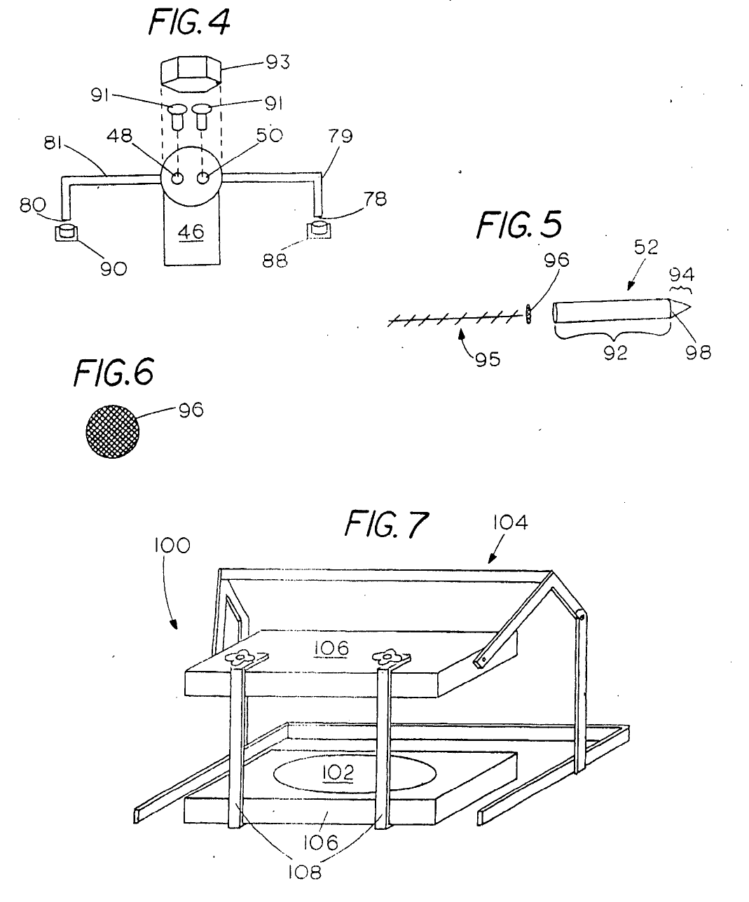

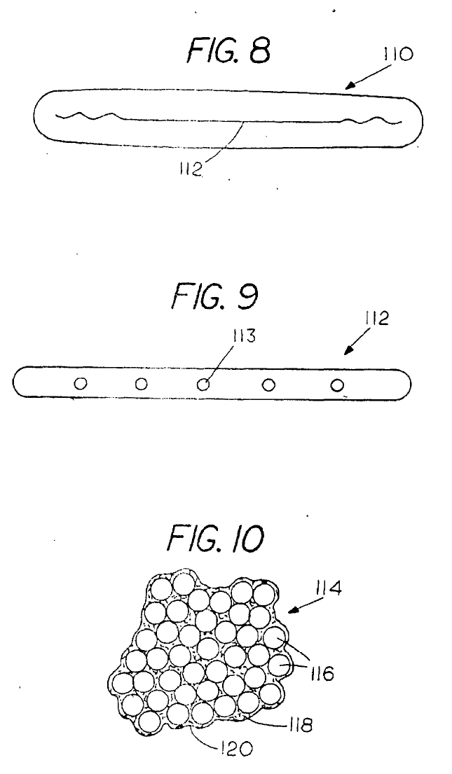

Compound A, which may be Isocyanate and compound B, which may be polyol, may be commingled through a mixing machine 20 as shown in FIGS. 3-6. A pair of tanks 22, 24, are joined to a work surface 25; one tank 22 for compound A and the other tank 24 for compound B. Each tank 22, 24 is joinable, perhaps via a seal and clamp (not shown), containing fumes, to covers 26, 28. The covers 26 and 28 are shown in a lifted position. Covers 26 and 28 may defined ambient air ports 30, 32 to equalize pressure inside the tanks 22, 24 as compound A and compound B are removed from tanks 22, 24. Each of the tanks 22, 24 are joined, at the bottom 34, 36, to a piston 38, 40, which obtains fluid from the respective tank 22, 24 and directs it down a line 42, 44 to a gun 46. The gun 46, with adjacent exit ports 48, 50, is joined to a static mixer 52 into which Compounds A and B are ejected, mixed and dispensed. The static mixer 52, circumscribes both exit ports 48, 50 simultaneously.

A suitable mixer 20 with the features described in the preceding paragraph is the Meter Master II Meter Mixing Machine Model MM2-0116 manufactured by Michael Engineering Ltd., having a business address of 5625 Venture Way, Mount Pleasant, Mich. 48858, the disclosure of which is hereby incorporated by reference. The present inventive mixing machine 20 has additional features described further below.

The cover 28 may have a mixer 54 extending therethrough, including a motor 56, a rotating shaft 58 and a paddle 60. The mixer 54 is sized, adapted and positioned to stir compound B in tank 24. The cover 28 may also have an injector 62, including a container 64 and a tube 66, wherein the tube 66 extends through an aperture 67 defined through the cover 28. The tube 66 may have a straight section 68 and a curled section 70. The curled section 70 may be positioned in a plane that is parallel to a plane in which the bottom 36 of tank 24 lies. The tube 66 may be pointed upstream or downstream of any currents in compound B generated by the mixer 54.

The container 64 may be sized, adapted and structured to hold a quantity 72 of Enovate 3000 perhaps with a space 74 thereabove. Enovate 3000 is a proprietary compound available through Honeywell, Inc., having a business address of Specialty Materials, 101 Columbia Road, Morristown N.J. 07962. The container 64 may be joined to a nitrogen (N₂) supply 76 via a tube 77. Nitrogen from the nitrogen supply 76 may fill the space 74 biasing against the quantity 72 of Enovate 3000 (or equivalent), desirably at a pressure of about two (2) psi.

The gun 46 may have auxiliary ports 78, 80, disposed at the end of tubes 79,81. Auxiliary ports 78,80 are respectively joined to lines 42, 44 and are positioned in a spaced apart position. The distance 82 between the auxiliary ports 78,80 is larger than the distance 84 between adjacent edges of tanks 22,24 and is smaller than the distance 86 between opposing edges of tanks 22,24. That is, the preferred distance 82 between auxiliary ports 78, 80 is both far enough and close enough to allow each to dispense into respective tanks 22, 24. Caps 88, 90 close the auxiliary ports 78, 80 when not in use and are removable to permit use of the auxiliary ports 78, 80. A pair of plugs 91 held by a retention cap 93 may preclude emissions from the exit ports 48, 50 when the auxiliary ports 78, 80 are used.

The static mixer 52 may generally be constructed in the manner of or similar to the static mixer 52 sold under the tradename Statomix, manufactured by Conprotec, Inc., having a business address of 8 Willow Street, Salem N.H. 03079. The static mixer 52, shown in FIG. 5 has a tube portion 92 joined to necked-down portion 94 and may have a constant wall thickness throughout the length. A screen 96, which may have a diameter slightly smaller than an interior diameter of the tube portion 92 is placed into the static mixer 52. The screen 96 lodges at the junction 98 between the tube portion 92 and necked-down portion 94. The screen 96 may be formed of any material, but most preferably is formed of iron. The screen 96 may be 60×60 mesh to 90×90 mesh with a wire diameter ranging from 0.0055 inch to 0.0075 inch and most preferably a perforated sheet with a hole diameter of 0.033 inch and percentage open area of 28%. The mixing stem 95 is positioned in the tube portion 92 adjacent the screen 96.

The mold 100 may have any shaped cavity 102 and be sized, adapted and structure for production of foam parts. The mold 100 desirably can withstand pressures of at least 30 psi and most preferably at least 100 psi in the part area without deforming of the mold 100 or allowing escape of the isocyanate/polyol mixture. A suitable mold 100 has been made and tested for forming surf-board blanks 110 out of cement positioned in an iron frame 104. The frame 104 allows for movement of the mold halves 106. The frame 104, weight of the mold halves 106 and/or clamps 108 may be used to hold the mold halves 106 together in a sealed engagement as the pressure inside the mold 100 is increased.

### Method of Mixing and Composition of Compounds A and B

Compound A, isocyanate, is poured into tank 22. The preferred isocyanate are Dow 143L and Mondur-CD; both MDI. Dow 143L, manufactured by Dow Chemical Company, having a business address of La Porte Plant P4, Miller Cutoff Road, La Porte Tex. 77572-000 and Mondur-CD, manufactured by Bayer Material Science LLC, having a business address of 100 Bayer Road, Pittsburgh Pa. 15205-9741 are isocyanates that appear to yield a whiter foam.

Compound B, polyol, is poured into tank 24. The preferred polyol is prepared in accordance with the instructions and additives and optionally additional additives as set forth above in the section entitled “methodology of preparing an improved compound B”. Most desirably, the improved polyol used in the compound B has a high green content.

Enovate 3000, available through Honeywell, having a business address of 101 Columbia Road Morristown, N.J. 07962 or equivalent is poured into container 64. Nitrogen from nitrogen supply 76 biases against the Enovate.

Compounds A and B are homogenized throughout the system. Caps 88, 90 are removed to uncover auxiliary ports 78, 80. Auxiliary ports 78, 80 are directed into tanks 22, 24 respectively, thereby directing compound A into tank 22 and compound B into tank 24. Compounds A and B are thereafter cycled until compounds A and B appear homogenized to the naked eye and the fluid ejections appear synchronized. The mixer 54 may be used to improve homogenization. Twenty-four cycles with the Meter Master 11 is generally sufficient.

The mixing machine 20 is then weight calibrated. The mixing machine 20 is cycled a known number of times, perhaps into two equal mass cups—one cup for compound A and one cup for compound B. The weights of the ejected compounds A and B are compared. Adjustments may be made to the mixing machine 20 according to standard adjustment techniques such that the amount of compounds A and B are ejected in the ratio desired to meet the consumers needs. The higher the weight of compound A relative to B, the foam production will occur at a higher temperature, and will yield a more course and more dense foam 114.

After homogenization, synchronization and calibration, the covers 26, 28 may be sealed and clamped to tanks 22, 24 respectively to limit the spread of fumes. Caps 88, 90 may be rejoined to seal auxiliary ports 78, 80. The screen 96 is positioned in the static mixer 52. The mixing stem 95 is positioned in the tube portion 92 of the static mixer 52 adjacent the screen 96. The static mixer 52 is sealably joined to the gun 46 and about the exit ports 48, 50. At this point, mixing machine 20 is suitably prepared to eject a compounds A and B in a homogenous mix.

Compounds A and B are mixed and ejected from the static mixer 52 through cycling the mixing machine 20. Specifically, pistons 38, 40 drive compounds A and B through lines 42, 44 and into the gun 46. The gun 46 ejects compounds A and B out through exit ports 48, 50 and into the static mixer 52. Compounds A and B fold over each other much in the manner of taffy making as they pass along the mixing stem 95. Mixed compounds A and B are then pressed through screen 96 breaking apart any large pockets of non-mixed material. Thereafter, the mixture of compound A and B is ejected out of the necked-down portion 94 of the static mixer 52 and into the mold 100.

### Method of Molding

Determining the amount of blended compound A and B to be placed into the mold 100 may be done by trial and error. The preferred quantity to be placed in a mold 100 is an amount greater than that which is sufficient to free fill the mold 100. This causes a pressure greater than ambient within the mold 100 while the foam 114 is forming, which will be discussed further below.

The mold 100 may be prepared for making blanks 110. Non-foam inserts 112 that are desired to be incorporated into the foam 114 may be set in the mold 100.
For instance, Kevlar® may be place in the mold 100. It has been found that foam 114 made according to the present system with embedded Kevlar, perhaps in the middle, is sufficient to stop small caliber bullets without significant degradation of the foam 114. Accordingly, it is thought that bullet-proof vests made of foam with embedded Kevlar should be made according to the disclosed system and tested to determine suitability and reliability.
As another example of an insert, a stringer or an S-stringer 112 may be positioned into the mold 100. A stringer is essentially a rudder used in a surf board; a portion of which extends the entire length of the board internally and a portion of which is exposed along a rear portion of the board. An S-stringer 112 is a stringer with a wave pattern curves at either end of the board. The stringer may include apertures 113 defined therethrough to allow some foam 114 on either side of the board to communicate through the stringer prior to hardening.
   Other inserts 112 may be placed in the mold 100 depending upon the product desired.

Once the mold 100 is prepared, the predetermined amount of mixture of compounds A and B is placed into the mold 100. The mixture of A and B should be proportionately distributed about the insert 112 to accurately position and maintain the insert 112. The insert 112 may move or the density of the foam 114 may be uneven in character if the disbursal is not proportionate.

The mold 100 is closed and clamped, using clamps 108, immediately upon placing the blended compounds A and B into the mold 100. The reaction between compounds A and B is believed to begin initiating once in the static mixer 52 and it takes perhaps 5 minutes to go to completion. The temperature and pressure have been observed to rise gradually, while the foam 114 is forming.

The increased temperature and/or pressure is believed to aid in development of crystalline matrix 120 in the interstitial space 118 between the cells 116. Aragonite, the high temperature cousin of calcite, is believed to be the crystalline matrix 120 that adds structural support between the cells 116 and stability to the foam 114. Desirably, the pressure inside the mold 100, while foam 114 is forming, is at least 5 psi, more preferably the pressure is at least 13 psi, and most preferably the pressure is at least 15 psi.

Once the foam 114 sets, the pressure drops rapidly. At this point, the foam 114 may be removed from the mold 100 and allowed to cure outside the mold 100. The molded foam 114 is thereafter subject to finish processing such as shaping and coating with fiberglass or other materials.

### Foam Apparatus

Rigid green closed cell foam 114 with high whiteness may be made with MDI, according to the above disclosed methods. Petroleum based polyols and TDI, while usable with the present system are not desirable for ecological reasons. “Rigid foam”, as used herein, is defined as a cellular plastic that is not deemed flexible according to ASTM D-883, which defines. “flexible foam” to be “a cellular plastic is considered flexible if a piece eight inches by one inch by one inch can be wrapped around a one inch mandrel at room temperature.” “Green foam”, an environmentally sound foam, is defined as a foam having at least an 8% renewable content pursuant to ASTM Method D 6866. Closed cell foam is defined as “a foam having an contiguous wall that completely encapsulates an interior space”. “High whiteness” is defined to be a color that can have a whiteness defined by a Hunter lab coordinate L value of at least about (90) and also having a brightness of at least about (70), as measured by a Technibrite TB-1C instrument (Tappi T 525) or whiter pursuant to ASTM E313, indicating the foam to be high quality and non-aged. The resultant foam 114 is found to be fine cell, e.g., greater than 100 cells per inch with a crystalline matrix, believed to be aragonite disposed in the interstitial space 118 between the cells 116. Shrinkage during the curing process has not been discernable to the naked eye.

SF100 is an internal test to determine shrinkage or collapse during curing. A linear measurement is taken at a determined point around the perimeter immediately after removing the foam from the mold. A period of time is allowed for curing. The sample is then remeasured at the same point about the perimeter. The two measurements are compared to the determine shrinkage or collapse.

SF200 is an internal test to determine effects of aging. This is based upon the Von't Hoff or Q10 principle. The principle states that chemical reaction rates double for every 10 degrees C. increase over room temperature of 22 degrees C. The test was operated at 60 degrees C. The formula is:

Time₁=time₂/Q₁₀^{[(t}^{₁}^{-t}^{ᵣₜ}^{/10]}

Time₁ is aged time, time₂ is actual time, Q₁₀ is reaction rate of coefficient (assumed to be 2), t₁ is over aging temperature and tᵣₜ is room or storage temperature. This test was used to determine aging effects on polyol solutions.

SF300 is an internal test to determine hardness. A shore scale durometer, type O, was used with ten readings taken at various random points on the foam. The range, average and median were determined. Durometer determines hardness. See also ASTM 2240.

The resultant foam may have one or more of the following characteristics:

TABLE 3

Renewable content of at least 8%, more preferably at least
12% and most preferably in access of 20%.
Rigid
Whiteness of at least 85 L value, Brightness 75, more
preferably at least 90 L value, Brightness 75, and most
preferably at least L value 90, Brightness 80.
Shrinkage of no more than 2% (linear length), more
preferably no more than 1% (linear length), and most
preferably no more than .5% (linear length).
Cells per inch of at least 85, more preferably at least 100,
and most preferably at least >100.
Crystalline matrix between the cells.

The following foams were made according to the process described with respect to each example and yielded the test results as provided.

### Example 17

A foam was prepared using Bayer Mondur-CD of isocyanate (Compound A) and the improved polyol based upon BJB prepared in accordance with the explanation set forth in Example 10. The weight of isocyanate mixed with the polyol was in the ratio 98 to 100, which is typically referenced as 98/100 in the field. Compounds A and B were homogenously blended and placed into a mold as described above.

The foam was tested pursuant to ASTM D6866 and determined to have a renewable content of 6% by Beta Analytical Inc., having an address of 4985 SW 74 Court, Miami, FLA 33155. The test had an absolute range of 6% (plus or minus 3%). This sample was understood to have 0% renewable. Accordingly, said foam is not “green”.

The foam was tested pursuant to ASTM D-883 and was too rigid to be deemed flexible pursuant to said test, and accordingly was rigid.

The foam was tested for whiteness pursuant to ASTM E313 and found to have a whiteness of L (89) Brightness (75).

The foam was tested for shrinkage according to SF100 test method (“Quantifiable Shrink/Collapse”). On Aug. 11, 2008 the sample measured 43¼″. On Aug. 22, 2009, nearly a year later, the sample was 43¼″, e.g. unchanged.

The number of cells per inch was measured to be at least 100 per inch. The crystalline matrix, believed to be aragonite, was observed between the cells.

The foam was tested according to test method SF300 and found to have a durometer range of 44-46, average 45 of and median of 45.

### Example 18

A foam was prepared using Bayer Mondur-CD of isocyanate (Compound A) and the improved polyol based on Cargil's BiOH prepared in accordance with the explanation set forth in Example 1. The weight of isociante mixed with the polyol was in the ratio 98 to 100, which is typically referenced as 98/100 in the field. Compound A and B were homogenously blended and placed into a mold as described above.

The foam was tested pursuant to ASTM D6866 and determined to have a renewable content of 37% by Beta Analytical Inc., having an address of 4985 SW 74 Court, Miami, FLA 33155. The test had an absolute range of 6% (plus or minus 3%). Accordingly, said foam is “green”.

The foam was tested pursuant to ASTM D-883 and was too rigid to be deemed flexible pursuant to said test, and accordingly was rigid.

The foam was tested for whiteness pursuant to ASTM E313 and found to have a whiteness of L (91) Brightness (80).

The foam was tested for shrinkage according to SF100 test method (“Quantifiable Shrink/Collapse”). On Aug. 22, 2008 the sample measured 43⅛″. On Sep. 5, 2009, the sample was 43⅛″, e.g. unchanged.

The number of cells per inch was measured to be at least 100 per inch. The crystalline matrix, believed to be aragonite, was observed between the cells.

The foam was tested according to test method SF300 and found to have a durometer range of 34-36, average of 34.9 and median of 34.

### Example 19

A foam was prepared using Bayer Mondur-CD of isocyanate (Compound A) and the improved polyol based on BioTechnologies Inc.'s Agrol prepared in accordance with the explanation set forth in Example 2. The weight of isociante mixed with the polyol was in the ratio 96.5 to 100. Compound A and B were homogenously blended and placed into a mold as described above.

The foam was tested pursuant to ASTM D6866 and determined to have a renewable content of 28% by Beta Analytical Inc., having an address of 4985 SW 74 Court, Miami, FLA 33155. The test had an absolute range of 6% (plus or minus 3%). Accordingly, said foam is “green”.

The foam was tested pursuant to ASTM D-883 and was too rigid to be deemed flexible pursuant to said test, and accordingly was rigid.

The foam was tested for whiteness pursuant to ASTM E313 and found to have a whiteness of L (93.5) Brightness (81).

The foam was tested for shrinkage according to SF100 test method (“Quantifiable Shrink/Collapse”). On Jul. 25, 2009 the sample measured 43¼″. On Aug. 22, 2009, the sample was 43¼″, e.g. unchanged.

The number of cells per inch was measured to be at least 100 per inch. The crystalline matrix, believed to be aragonite, was observed between the cells.

The foam was tested according to test method SF300 and found to have a durometer range of 72-76, average of 74.4 and median of 75.

### Example 20

A foam was prepared using Bayer Mondur-CD of isocyanate (Compound A) and the improved polyol based on Urethane Soy Systems' Soyol prepared in accordance with the explanation set forth in Example 13. The weight of isociante mixed with the polyol was in the ratio 100 to 100, which is typically referenced as 100/100 in the field. Compound A and B were homogenously blended and placed into a mold as described above.

The foam was tested pursuant to ASTM D6866 and determined to have a renewable content of 20% by Beta Analytical Inc., having an address of 4985 SW 74 Court, Miami, FLA 33155. The test had an absolute range of 6% (plus or minus 3%). Accordingly, said foam is “green”.

The foam was tested pursuant to ASTM D-883 and was too rigid to be deemed flexible pursuant to said test, and accordingly was rigid.

The foam was tested for whiteness pursuant to ASTM E313 and found to have a whiteness of L (90) Brightness (68).

The foam was tested for shrinkage according to SF100 test method (“Quantifiable Shrink/Collapse”). On Apr. 9, 2009 the sample measured 13⅝″. On Aug. 22, 2009, nearly a year later, the sample was 13⅝″, e.g. unchanged.

The number of cells per inch was measured to be at least 100 per inch. The crystalline matrix, believed to be aragonite, was observed between the cells.

The foam was tested according to test method SF300 and found to have a durometer range of 6-12, average 9.6 of and median of 10.

### Example 21

A foam was prepared using Dow 143L isocyanate (Compound A) and the improved polyol based on BJB was prepared in accordance with the explanation set forth in Example 7. The weight of isociante mixed with the polyol was in the ratio 79 to 100, which is typically referenced as 79/100 in the field. Compound A and B were homogenously blended and placed into a mold as described above.

The foam was tested pursuant to ASTM D6866 and determined to have a renewable content of 6% by Beta Analytical Inc., having an address of 4985 SW 74 Court, Miami, FLA 33155. The test had an absolute range of 6% (plus or minus 3%). This foam was understood to have a renewable content of 0%. Accordingly, said foam is not “green”.

The foam was tested pursuant to ASTM D-883 and was too rigid to be deemed flexible pursuant to said test and accordingly is rigid.

The foam was tested for whiteness pursuant to ASTM E313 and found to have a whiteness of L (89) Brightness (75).

The foam was tested for shrinkage according to SF100 test method (“Quantifiable Shrink/Collapse”). It was found the product did not vary from dimensions of mold that it was processed in, e.g., unchanged.

The number of cells per inch was measured to be at least 100 per inch, but of slightly varying diameters.

The crystalline matrix, believed to be aragonite, was observed between the cells.

The foam was tested according to test method SF300 and found to have a durometer range of 43-55, average of 49.2 and median of 49.

The present invention has been described with reference to the appended drawings disclosing the best mode of making and using the invention in sufficient detail as to allow one or ordinary skill in the art to make and use the invention. Modifications can be made without departing from the spirit and scope of the present invention.

We claim:

1) An improved polyol, comprising:
a first component combined with a second component, one of the first and second components being hydrophobic and one of the first and second components being hydrophillic, at least one of the components being in a stable encapsulation.

2) The improved polyol of claim 1 wherein the first component is oil.

3) The improved polyol of claim 2 wherein the oil is renewable oil.

4) The improved polyol of claim 1 wherein the first component is water.

5) The improved polyol of claim 4 wherein the second component is oil.

6) The improved polyol of claim 1 wherein the first component is encapsulated.

7) The improved polyol of claim 6 wherein the first component is in an emulsion.

8) The improved polyol of claim 1 further comprising calcium carbonate and silicon dioxide.

9) The improved polyol of claim 8 wherein the calcium carbonate and silicon dioxide encapsulate one of the first and second components.

10) The improved polyol of claim 8 wherein the calcium carbonate and silicon dioxide emulsify one of the first and second components.

11) The improved polyol of claim 8 wherein the calcium carbonate constitutes between 2% and 30% by weight of the first and second components.

12) The improved polyol of claim 8 wherein the silicon dioxide constitutes between 2% and 30% by weight of the first and second components.

13) The improved polyol of claim 12 wherein the calcium carbonate constitutes between 2% and 30% by weight of the first and second components.

14) The improved polyol of claim 1 wherein the first component and the second component are in an emulsion.

15) An improved polyol, comprising:
a first component and a second component, one of the first and second components being hydrophobic and one of the first and second components being hydrophillic, at least one of the components being mixed in a stable emulsion.

16) An improved polyol, comprising:
water,
oil;
CaCO₃; and
SiO₂, wherein the water, CaCO₃ and SiO₂ form an emulsion.

17) An improved polyol, comprising:
water,
oil;
CaCO₃; and
SiO₂, wherein the CaCO₃ and SiO₂ encapsulate the water.

18) An improved polyol, comprising:
water,
oil; the weight of the water and weight of the oil form a total water-oil weight;
CaCO₃, wherein a weight of the CaCO₃ is between 2% and 30% of the water-oil weight; and
SiO₂, wherein a weight of the SiO₂ is between 2% and 30% of the water-oil weight.
